(19) United States
(12) Patent Application Publication
(10) Pub. No.: US 2009/0106499 A1
(43) Pub. Date: Apr. 23, 2009

(54) Processor with prefetch function

(75) Inventors: Hidetaka Aoki, Tokyo (JP); Naonobu Sukegawa, Inagi (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/071,022

(22) Filed: Feb. 14, 2008

(30) Foreign Application Priority Data
Oct. 17, 2007 (JP) 2007-269885

(51) Int. Cl. G06F 12/08

(52) U.S. Cl. 711/137; 711/E12.057

(57) ABSTRACT

Non-speculatively prefetched data is prevented from being discarded from a cache memory before being accessed. In a cache memory including a cache control unit for reading data from a main memory into the cache memory and registering the data in the cache memory upon reception of a fill request from a processor and for accessing the data in the cache memory upon reception of a memory instruction from the processor, a cache line of the cache memory includes a registration information storage unit for storing information indicating whether the registered data is written into the cache line in response to the fill request and whether the registered data is accessed by the memory instruction. The cache control unit sets information in the registration information storage unit for performing a prefetch based on the fill request and resets the information for accessing the cache line based on the memory instruction.

### CLAIM OF PRIORITY

The present application claims priority from Japanese application P2007-269885 filed on Oct. 17, 2007, the content of which is hereby incorporated by reference into this application.

### BACKGROUND OF THE INVENTION

This invention relates to the improvement of a processor including a cache memory, in particular, to the improvement of a vector processor for prefetching data into the cache memory.

For a super-computer which processes a large amount of data, a vector processor is widely used. As a technique of improving the performance of the vector processor, “Cache Refill/Access Decoupling for Vector Machines” by Christopher Batten, Ronny Krashinsky, Steve Gerding, and Krste Asanović, published by Computer Science and Artificial Intelligence Laboratory, Massachusetts Institute of Technology, searched online on Sep. 20, 2007, URL <http://www.mit.edu/˜cbatten/work/vpf-talk-caw04.pdf> (hereinafter, referred to as Non-Patent Document 1) proposes the separation of a prefetch function and a load access function (or a store access function). The prefetch function pre-fills a cache memory (hereinafter, referred to simply as a cache) included in the vector processor with data required for an arithmetic operation. The load access function reads the data on the cache into a register (or a vector register) (or the store access function writes the data to the cache).

In response to a vector load instruction (hereinafter, referred to simply as a load instruction) for reading data into the vector processor, a fill request is issued prior to the load access for storing the data in the vector register. As a result, a non-speculative hardware prefetch is realized. By reducing the number of cache misses in this manner, the performance of the vector processor is intended to be improved, whereas the amount of hardware (for example, a circuit area) for accessing a main memory is reduced.

Specifically, according to Non-Patent Document 1 described above, upon reception of the load instruction, the prefetch function issues the fill request to a cache control unit for controlling the cache to execute the non-speculative prefetch. Thereafter, the load access function executes the load instruction to allow the data on the cache to be read. In the vector processor, a single arithmetic instruction generally causes the processing of a large number of pieces of data. Therefore, when the arithmetic instruction precedes the load instruction, a cycle time from the reception of the load instruction by the prefetch function to the actual execution of the load instruction becomes long. Therefore, according to Non-Patent Document 1 described above, the use efficiency of the cache can be improved by the non-speculative prefetch.

A technique of simply prefetching the data into the cache (for example, a speculative prefetch) has been realized not only in the vector processor but also in an x86-based scalar processor or the like (or a general-purpose processor). The above-described Non-Patent Document 1 differs from the above-mentioned technique in that the prefetch function and the load access function are mounted in the hardware in a separated manner to realize a non-speculative prefetch for prefetching data which is sure to be accessed by a load access in the future.

Moreover, as a technique of preventing the data prefetched into the cache from being discarded prior to the load access, a technique using software is known. For example, an e200z6 PowerPC core fabricated by Freescale Semiconductor, Inc. includes cache lock prefetch instructions (dcbtls, dcbtstls, and icbtls) and cache unlock instructions (dcblc and icblc). In this type of processor, the prevention of the discard of the data can be realized by pre-compiling an instruction sequence of the cache lock prefetch instruction, a load instruction, the cache unlock instruction and the like.

### SUMMARY OF THE INVENTION

According to the above-described Non-Patent Document 1, upon the reception of the load instruction, the prefetch function issues a fill request to the cache control unit to execute the non-speculative prefetch. Thereafter, the load access function executes the load instruction to read the data on the cache.

According to Non-Patent Document 1, however, when a large number of load instructions are issued or an enormously long cycle time is required for the arithmetic operation being executed prior to the load instruction, the data prefetched into the cache is discarded by a subsequent prefetch if the non-speculative prefetch by the prefetch function is executed too earlier than the execution of the load instruction. As a result, upon execution of the load instruction preceded by the prefetch, a cache miss occurs to disadvantageously degrade the performance of the vector processor.

With regard to the problem described above, Non-Patent Document 1 proposes a technique of providing a counter to restrain the number of fill requests to be issued to keep a total number of cache lines for the fill requests preceding the load access to a predetermined number or less.

According to this technique, the amount of increase in the size of the circuit to be mounted in the vector processor is advantageously small. However, the above-proposed technique has no effect when a large number of fill requests are issued to a certain cache index (for example, in the case of a power-of-two stride access). Accordingly, the problem of the discard of the prefetched data is not solved.

Furthermore, Non-Patent Document 1 described above discloses that the number of fill requests issued “on-the-fly” (processed in parallel) to one cache index is restrained to be equal to or less than the number of ways of cache lines. However, if a circuit for restraining the number of issued fill requests to be equal to or less than the number of ways of the cache lines is mounted, the circuit for cache control becomes complex. As a result, there arises a problem that the object of separating the prefetch function and the load access function from each other to reduce the amount of hardware is difficult to achieve.

Moreover, the combination of the cache lock prefetch instruction and the cache unlock instruction by the software described above with cache refill/access decoupling described in Non-Patent Document 1 can prevent the data prefetched on the cache from being discarded. In this case, however, it is necessary to insert the cache lock prefetch instruction and the cache unlock instruction by a compiler before and after the load instruction. Therefore, the cache lock prefetch instruction and the cache unlock instruction are needlessly executed even if the fill request does not greatly precede the load instruction at the actual execution of the instructions. As a result, the performance of the vector processor is degraded.

Furthermore, with cache refill/access decoupling described in Non-Patent Document 1, when the number of load accesses becomes equal to or exceeds that of fill requests, the fill request becomes a needless access to the cache to disadvantageously degrade the performance of the vector processor.

In view of the above-described problems, it is an object of this invention to prevent non-speculatively prefetched data from being discarded from a cache before being accessed and restrain an increase in the amount of hardware in a processor including a prefetch function and a memory access function in a separated manner. It is another object of this invention to prevent a needless cache access made by a fill request to ensure the performance of the processor when the number of memory accesses becomes equal to or exceeds that of the fill requests.

This invention provides a cache memory including: a cache control unit for reading data from a main memory to the cache memory to register the data in the cache memory upon reception of a fill request from a processor and for accessing the data in the cache memory upon reception of a memory access instruction from the processor, the processor including: a control unit for issuing the memory access instruction including a load instruction for reading the data from the cache memory and a store instruction for writing the data to the cache memory, and an arithmetic instruction for the data; an instruction executing unit for executing the instruction issued by the control unit; and a fill unit for receiving the memory access instruction issued by the control unit to issue the fill request for reading the data into the cache memory to the cache memory; and a plurality of cache lines, each being for storing the data in association with an address on the main memory. In the cache memory, each of the plurality of cache lines includes a registration information storage unit for storing information indicating whether the data registered in the each of the plurality of cache lines is written to the each of the plurality of cache lines in response to the fill request and whether the data registered in the each of the plurality of cache lines is accessed by the memory access instruction, and the cache control unit sets predetermined information to the registration information storage unit when the data read from the main memory is registered in one of the plurality of cache lines based on the fill request and resets the predetermined information in the registration information storage unit when the data in the one of the plurality of cache lines is accessed based on the memory access instruction.

Further, the cache control unit selects one of the plurality of cache lines, in which the predetermined information in the registration information storage unit has been reset, when new data is read from the main memory to be registered in the cache memory.

Further, a processor includes: a cache memory including a plurality of cache lines, each being for storing data in association with an address of a main memory; a control unit for issuing a memory access instruction including a load instruction for reading data from the cache memory and a store instruction for writing data to the cache memory, and an arithmetic instruction for the data; an instruction executing unit for executing the instruction issued by the control unit; a fill unit for receiving the memory access instruction issued by the control unit to issue a fill request for reading the data into the cache memory to the cache memory; and a cache control unit for reading the data from the main memory into the cache memory to register the data in the cache memory upon reception of the fill request and for accessing the data in the cache memory upon reception of the memory access instruction from the instruction executing unit. In the processor, each of the plurality of cache lines includes a registration information storage unit for storing information indicating whether the data registered in the each of the plurality of cache lines is written to the each of the plurality of cache lines in response to the fill request and whether the data registered in the each of the plurality of cache lines is accessed in response to the memory access instruction, and the cache control unit sets predetermined information to the registration information storage unit for registering the data read from the main memory based on the fill request in one of the plurality of cache lines and resets the predetermined information in the registration information storage unit for accessing the data in the one of the plurality of cache lines based on the memory access instruction.

Further, the processor includes an issue control unit for controlling the fill unit by counting the number of the fill requests issued by the fill unit and the number of the memory access instructions issued by the instruction executing unit to prevent the number of the memory access instructions from being equal to or larger than the number of the fill requests.

Thus, according to this invention, the fill unit for executing the non-speculative prefetch prior to the memory access instruction and the instruction executing unit for executing the memory access instruction to make an access to the cache memory are provided separately. The registration information storage unit provided for each of the plurality of cache lines of the cache memory explicitly indicates that data registered in the each of the plurality of cache lines is written to the each of the plurality of cache lines in response to the fill request and that the data is accessed by the memory access instruction. As a result, when predetermined information is set in the registration information storage unit, the data can be prevented from being discarded from the cache memory by a subsequent memory access instruction. Therefore, a cache hit is ensured by the memory access instruction corresponding to the fill request. Accordingly, the performance of the processor can be improved, while the amount of hardware is restrained from being increased, as happened in the related art.

Moreover, the number of fill requests issued by the fill unit and the number of memory access instructions issued by the instruction executing unit are counted to control the fill unit to prevent the number of memory access instructions from being equal to or larger than the number of fill requests. As a result, a needless cache access by the fill request preceded by the memory access instruction is prevented to improve the performance of the processor. Furthermore, the fill request is issued prior to the memory access instruction to perform a non-speculative prefetch. As a result, a cache miss is prevented to improve the performance of the processor.

### BRIEF DESCRIPTION OF THE DRAWINGS

FIG. 1 is a block diagram of a computer including a vector processor to which this invention is applied according to a first embodiment of this invention.

FIG. 2 is a block diagram illustrating an example of a cache line according to the first embodiment of this invention.

FIG. 3 is an explanatory view illustrating an example of an instruction system according to the first embodiment of this invention.

FIG. 4 is an explanatory view illustrating another example of the instruction system according to the first embodiment of this invention.

FIG. 5 is a block diagram illustrating a structure of an instruction issued by a fill unit and a load/store/arithmetic unit to a cache control unit according to the first embodiment of this invention.

FIG. 6 is a flowchart illustrating an example of processing executed in an issue control unit according to the first embodiment of this invention.

FIG. 7 is a flowchart illustrating an example of processing executed in the fill unit according to the first embodiment of this invention.

FIG. 8 is a flowchart illustrating an example of processing executed in the load/store/arithmetic unit according to the first embodiment of this invention.

FIG. 9 is a flowchart illustrating a main routine of an example of processing executed in a cache control unit according to the first embodiment of this invention.

FIG. 10 is a flowchart illustrating a subroutine of a cache control 1 in the example of the processing executed in the cache control unit according to the first embodiment of this invention.

FIG. 11 is a flowchart illustrating a subroutine of another cache control 2 in the example of the processing executed in the cache control unit according to the first embodiment of this invention.

FIG. 12 is a block diagram of a computer including a multi-core vector processor to which this invention is applied according to a second embodiment of this invention.

FIG. 13 is a block diagram illustrating an example of a cache line according to the second embodiment of this invention.

FIG. 14 is a flowchart of a subroutine of a cache control 1 in an example of processing executed in the cache control unit according to the second embodiment of this invention.

FIG. 15 is a flowchart of a subroutine of another cache control 2 in the example of the processing executed in the cache control unit according to the second embodiment of this invention.

### DETAILED DESCRIPTION OF THE PREFERRED EMBODIMENTS

Hereinafter, embodiments of this invention will be described based on the accompanying drawings.

### First Embodiment

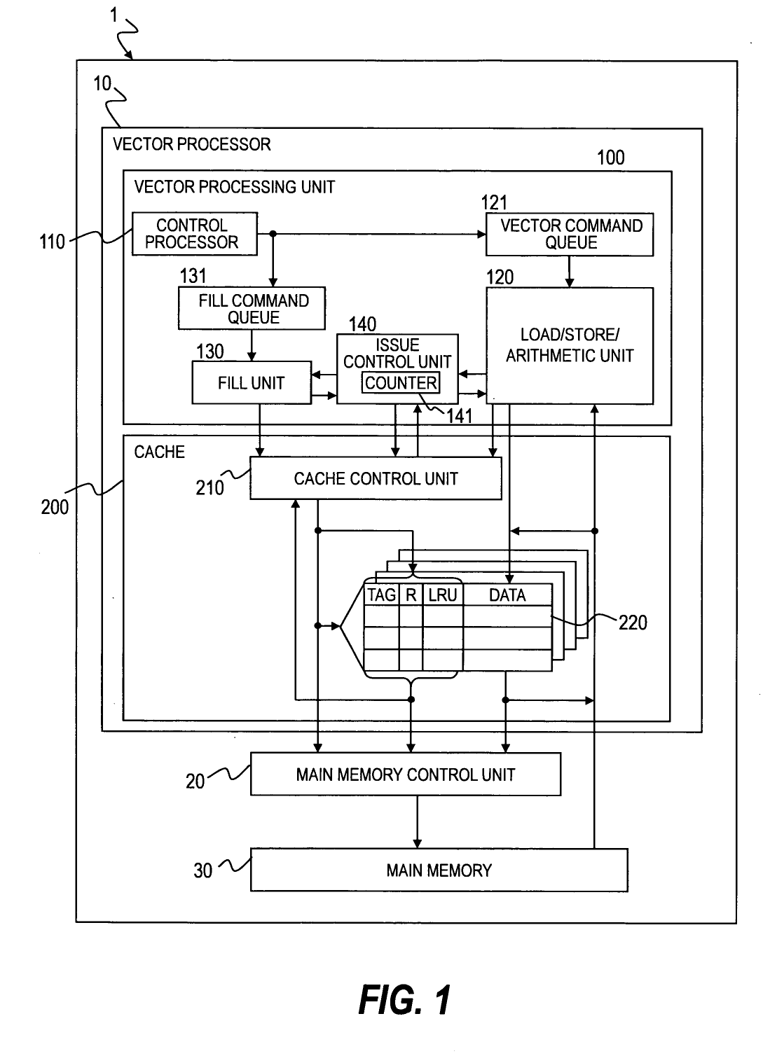

FIG. 1 illustrates a first embodiment of this invention and is a block diagram of a computer including a vector processor to which this invention is applied.

A computer 1 includes a vector processor 10 for performing a vector operation, a main memory 30 for storing data and programs, and a main memory control unit 20 for accessing the main memory 30 based on an access request (read or write request) from the vector processor 10. The main memory control unit 20 is constituted by, for example, a chip set, and is coupled to a front side bus of the vector processor 10. The main memory control unit 20 and the main memory 30 are coupled to each other through a memory bus. The computer 1 may include a disk device or a network interface not illustrated in the drawing.

The vector processor 10 includes a cache memory (hereinafter, referred to simply as a cache) 200 for temporarily storing data or an instruction read from the main memory 30 and a vector processing unit 100 for reading the data stored in the cache 200 to execute the vector operation.

The vector processing unit 100 mainly includes a control processor 110, a vector command queue 121, a load/store and arithmetic unit 120 (hereinafter, referred to as a load/store/arithmetic unit 120), a fill command queue 131, a fill unit 130, and an issue control unit 140. The control processor 110 issues an instruction sequence read from the cache 200 (or the main memory 30) to the queues (described below) of the load/store/arithmetic unit 120 and the fill unit 130 to control the entire vector processor 10. The vector command queue 121 temporarily stores an instruction from the control processor 110. The load/store/arithmetic unit 120 executes the instruction in the vector command queue 121. The fill command queue 131 temporarily stores a predetermined instruction (for example, a load instruction) from the control processor 110. The fill unit 130 issues an instruction for non-speculatively prefetching data from the main memory 30 into the cache 200 based on the predetermined instruction stored in the fill command queue 131. The issue control unit 140 controls the non-speculative prefetch instruction (fill request) issued by the fill unit 130 and an access to the cache 200, which is issued by the load/store/arithmetic unit 120. Specifically, the vector processor 10 includes the fill unit 130 for prefetching the data into the cache 200 and the load/store/arithmetic unit 120 for accessing the cache 200 in a separated manner and the issue control unit 140 for arbitrating the fill unit 130 and the load/store/arithmetic unit 120.

The cache 200 includes a cache control unit 210 and a plurality of cache lines 220. The cache control unit 210 receives the fill request from the fill unit 130 and the memory access instruction (the load instruction or the store instruction) from the load/store/arithmetic unit 120 to operate the cache line 220 containing the data corresponding to an address on the main memory 30, which is contained in each of the instructions. Each of the cache lines 200 stores a predetermined number of bytes of data. The cache 200 can be configured by, for example, an n-way set associative cache.

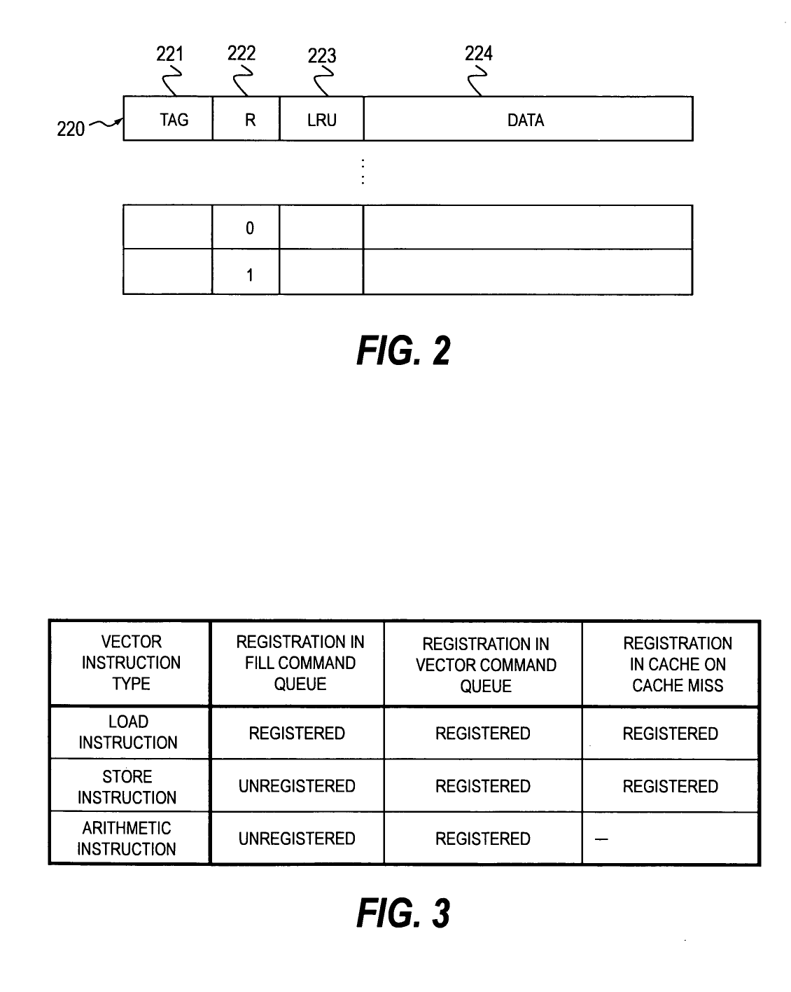

FIG. 2 illustrates a structure of the cache line 220. The cache line 220 includes a tag 221, a data unit 224, a least recently used (LRU) 223, and a registration state (R-bit) 222. The tag 221 stores a part of the addresses in the main memory 30. The data unit 224 is constituted to have a predetermined line size to store a part of the data in the main memory 30. The LRU 223 stores information indicating the order of accessing the cache lines 220 of each way and the way which is the next to be kicked out of the cache to store new information. The registration state 222 indicates a state of the cache line read by the non-speculative prefetch. In the structure of the cache line 220, a known technique can be used for the tag 221, the LRU 223, and the data unit 224 except for the registration state 222.

A value of the registration state 222 is set by the cache control unit 210. A value “1” indicates a state where data is read from the main memory 30 into the cache 200 and is not accessed by the load/store/arithmetic unit 120 yet. A value “0” indicates a state where an instruction corresponding to the non-speculative prefetch is executed by the load/store/arithmetic unit 120 to complete an access. As described below, the cache line 220, into which data is cached by the non-speculative prefetch prior to the load instruction, maintains “1” as the registration state 222 until the execution of a predetermined load instruction (or store instruction) to be prevented from being kicked out of the cache 200.

Next, FIG. 3 illustrates an example of the instructions issued by the control processor 110 of the vector processor 10 and the relation between the instructions stored in the fill command queue 131 and the vector command queue 121.

In an instruction system illustrated in FIG. 3, the control processor 110 issues the load instruction, the store instruction, and the arithmetic instruction and registers all the instructions in the vector command queue 121. On the other hand, the control processor 110 registers only the load instruction in the fill command queue 131. Furthermore, when the load/store/arithmetic unit 120 issues the load instruction and the store instruction to cause a cache miss, the cache control unit 210 registers the cache-miss data in the cache 200 from the main memory 30.

In the example illustrated in FIG. 3, upon issuance of the load instruction, the vector processor 10 registers the load instruction in the vector command queue 121 as well as in the fill command queue 131. The fill unit 130 executes a non-speculative prefetch for reading the data on the main memory 30, which corresponds to the load instruction registered in the fill command queue 131, into the cache line 220 of the cache 200.

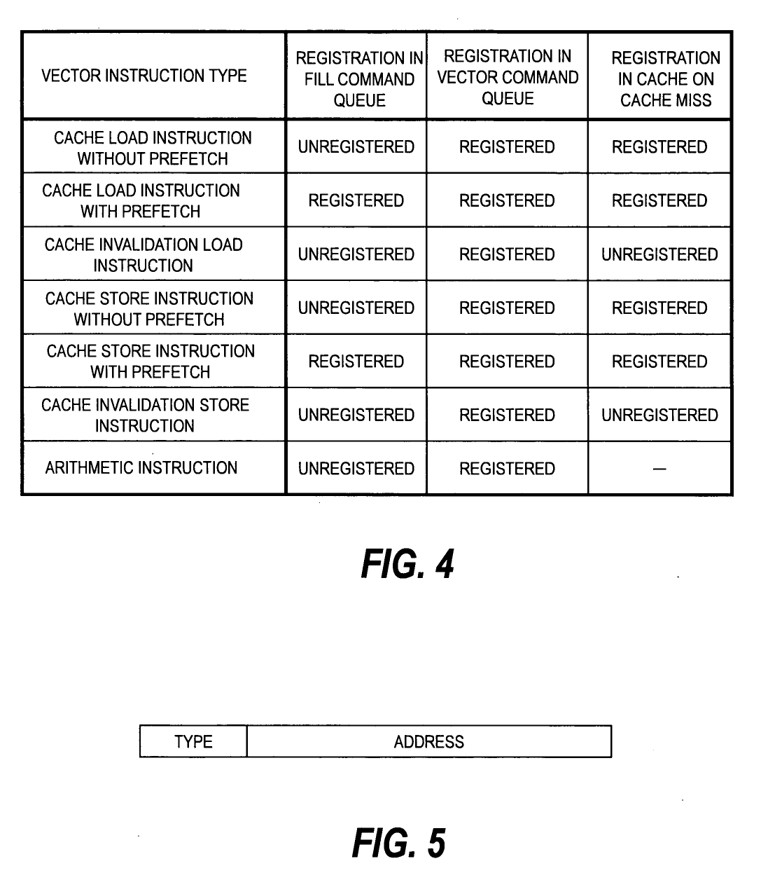

The vector processor 10 according to this invention can use an instruction system as illustrated in FIG. 4 in place of the simple instruction system illustrated in FIG. 3.

The instruction system illustrated in FIG. 4 includes the presence/absence of the non-speculative prefetch and an instruction without registration to the cache 200 in addition to the load instruction and the store instruction illustrated in FIG. 3.

A cache load instruction without prefetch allows data to be registered in the cache 200 on a cache miss at the execution of the load instruction without performing the non-speculative prefetch. Therefore, the cache load instruction without prefetch is registered only in the vector command queue 121 without being registered in the fill command queue 131.

A cache load instruction with prefetch is the same as the load instruction illustrated in FIG. 3, and executes the non-speculative prefetch. Therefore, the cache load instruction with prefetch is registered in both the fill command queue 131 and the vector command queue 121. On a cache miss at the execution of the load instruction, data in the main memory 30, which is designated by the load instruction, is registered in the cache 200.

A cache invalidation load instruction is for reading data from the main memory 30 into the load/store/arithmetic unit 120 at the execution of the load instruction, and is a load instruction without using the cache 200. The cache invalidation load instruction can be used to hold the data on the cache 200 even when a waiting time for reading the data from the main memory 30 into the load/store/arithmetic unit 120 is required.

As in the case of each of the load instructions, a cache store instruction with prefetch, a cache store instruction without prefetch, and a cache invalidation store instruction are defined for the store instruction.

In the following description, the instruction system illustrated in FIG. 4 is used. The cache load instruction with prefetch, the cache load instruction without prefetch, and the cache invalidation load instruction are collectively referred to as the load instruction, whereas the cache store instruction with prefetch, the cache store instruction without prefetch, and the cache invalidation store instruction are collectively referred to as the store instruction.

An instruction issued by the fill unit 130 and the load/store/arithmetic unit 120 to the cache control unit 210 includes a type of instruction indicating any of the load instruction, the store instruction and the fill request (prefetch instruction) and an address on the main memory 30, as illustrated in FIG. 5.

The fill unit 130 processes the cache load instruction (or store instruction) with prefetch registered in the fill command queue 131 in a sequential manner to issue to the cache control unit 210 an instruction (fill request) for prefetching the data at the address on the main memory 30, which is designated by the instruction, into the cache 200.

The issue control unit 140 monitors the memory access instructions (collective designation of the load instruction and the store instruction) with prefetch among the fill requests issued by the fill unit 130 and the load instructions or the store instructions issued by the load/store/arithmetic unit 120. When the number of the issued memory access instructions becomes equal to or exceeds the number of the issued fill requests, the fill request is discarded to prevent the cache control unit 210 from needlessly accessing the cache 200 or the main memory 30 or the fill request is issued in priority to the memory access instruction to restrain the occurrence of a cache miss. For this purpose, the issue control unit 140 includes a counter 141 for monitoring the number of fill requests issued by the fill unit 130 and the number of memory access instructions issued by the load/store/arithmetic unit 120.

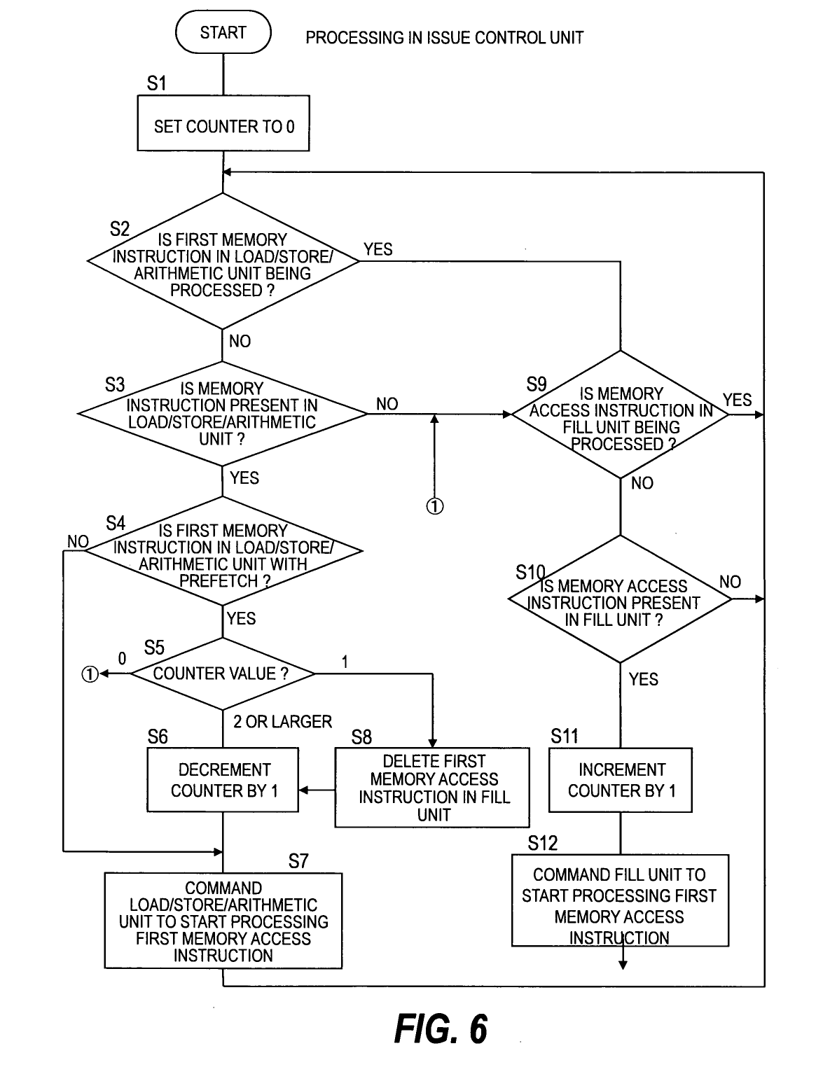

Next, FIG. 6 is a flowchart illustrating an example of processing executed in the issue control unit 140. In Step S1, the issue control unit 140 resets the counter 141 to the value of 0 for initialization upon activation of the vector processor 10.

Next, in Step S2, the issue control unit 140 monitors the load/store/arithmetic unit 120 to determine whether or not the load/store/arithmetic unit 120 is processing the memory access instruction read from the vector command queue 121 (the load/store/arithmetic unit 120 is accessing the cache 200 or the main memory 30). If the load/store/arithmetic unit 120 is processing the memory access instruction, the processing proceeds to Step S9 where the issue control unit 140 monitors the fill unit 130. If not, the processing proceeds to Step S3 where the issue control unit 140 monitors the load/store/arithmetic unit 120.

In Step S3, the issue control unit 140 determines whether or not the load/store/arithmetic unit 120 includes the memory access instruction read from the vector command queue 121, which is not executed yet. If the load/store/arithmetic unit 120 has the memory access instruction, the processing proceeds to Step S4. On the other hand, if not, the processing proceeds to Step S9.

In Step S4, it is determined whether or not the memory access instruction in the load/store/arithmetic unit 120 is with the fill request. If the memory access instruction is for prefetching the data prior to the execution of the memory access instruction in the fill unit 130 (the cache load instruction or store instruction with prefetch), the processing proceeds to Step S5. On the other hand, if the memory access instruction does not require the data prefetch (the cache load instruction without prefetch, the cache invalidation load instruction, the cache store instruction without prefetch, or the cache invalidation store instruction), the processing proceeds to Step S7.

In Step S5, the value of the counter 141 is determined to be any of 0, 1, and 2 or larger. If the value of the counter 141 is 0, the processing proceeds to Step S9 to move to processing in the fill unit 130. If the value of the counter 141 is 1, the processing proceeds to Step S8 where the memory access instruction read into the fill unit 130 is deleted. When the value is 2 or larger, the processing proceeds to Step S6 where the value of the counter 141 is decremented by 1.

If the counter 141 has a value of 1 or larger, it is indicated that the cache 200 has data which has not been accessed yet since being prefetched into the cache 200. If the counter 141 has a value of 0, the data prefetched in response to the cache load instruction or store instruction with prefetch is not in the cache 200. Specifically, the counter 141 serves as an index indicating how much the prefetch executed by the fill unit 130 precedes the memory access instruction with prefetch executed by the load/store/arithmetic unit 120.

With a value of the counter 141 being 0, if the memory access instruction with prefetch is next executed by the load/store/arithmetic unit 120, a cache miss occurs to waste a time required to read data from the main memory 30 into the cache 200. Therefore, in this case, the processing proceeds to Step S9 to execute the memory access instruction in the fill unit 130 to avoid the cache miss.

If the counter 141 has a value of 2 or larger, the prefetch into the cache 200 sufficiently precedes the memory access instruction with prefetch in the load/store/arithmetic unit 120. Therefore, after decrementing the value of the counter 141 by 1, the issue control unit 140 commands the load/store/arithmetic unit 120 to execute the instruction with prefetch in Step S7. Thereafter, the issue control unit 140 returns to Step S2 to repeat the above processing.

On the other hand, if the counter 141 has a value of 1, the processing proceeds to Step S8 where the issue control unit 140 commands the fill unit 130 to delete the memory access instruction read from the fill command queue 131 into the fill unit 130. Specifically, when the load/store/arithmetic unit 120 executes a next instruction with prefetch, the non-speculative prefetched data is no longer present on the cache 200 (the registration state 222 is reset). When the load/store/arithmetic unit 120 executes another memory access instruction with prefetch subsequent to the memory access instruction with prefetch, the prefetch in response to the memory access instruction read into the fill unit 130 is not sometimes performed in time for the subsequent memory access instruction. Therefore, when the counter 141 has a value of 1, the memory access instruction read into the fill unit 130, which causes the prefetch corresponding to the subsequent memory access instruction with prefetch, is deleted to prevent the fill unit 130 from performing a needless prefetch.

Next, if the load/store/arithmetic unit 120 is executing the memory access instruction in Step S2 described above, the processing proceeds to Step S9 where it is determined whether or not the fill unit 130 is processing the memory access instruction (memory access instruction with prefetch) read from the fill command queue 131. If the fill unit 130 is executing the memory access instruction, the processing returns to Step S2 to repeat the above described processing. On the other hand, if the fill unit 130 is not processing the memory access instruction, the processing proceeds to Step S10.

In Step S10, the issue control unit 140 determines whether or not the memory access instruction before being processed is present in the fill unit 130. If the fill unit 130 does not have the memory access instruction, the processing returns to Step S2 to repeat the above described processing. On the other hand, if the fill unit 130 has the memory access instruction, the processing proceeds to Step S11 where the counter 141 is incremented by 1. Then, the processing proceeds to Step S12. In Step S12, the issue control unit 140 commands the fill unit 130 to start processing the memory access instruction read from the fill command queue 131. Thereafter, the processing returns to Step S2 to repeat the above-described processing.

By the above-described processing, the issue control unit 140 determines which of the memory access instruction in the load/store/arithmetic unit 120 and the fill request in the fill unit 130 is to be prioritized based on the value of the counter 141 to control the issuance of the fill request. As a result, a cache miss is prevented from occurring to restrain a needless prefetch. Specifically, the issue control unit 140 controls the fill unit 130 and the load/store/arithmetic unit 120 to allow the non-speculative prefetch performed in response to the fill request to precede the cache memory access instruction with prefetch from the load/store/arithmetic unit 120. As a result, in the vector processor 10A which requires a long cycle time for one vector operation, even if the cache memory access instruction with prefetch is registered at substantially the same time in the fill command queue 131 and the vector command queue 121 from the control processor 110, a cache hit can be made upon the completion of the vector operation and the issuance of the memory access instruction corresponding to the fill request issued by the load/store/arithmetic unit 120 after the fill unit 130 issues the fill request and registers the fill request in the cache line 220 when the arithmetic instruction precedes the cache memory access instruction with prefetch in the vector command queue 121. However, since a cycle time required for the vector operation immediately before the cache memory access instruction with prefetch is unknown, the issue control unit 140 deletes the memory access instruction read into the fill unit 130 to prevent the non-speculative prefetch from being executed based on the memory access instruction after the issuance of the memory access instruction from the load/store/arithmetic unit 120 when the number of cache memory access instructions with prefetch is about to be equal to the number of fill requests (the counter=1).

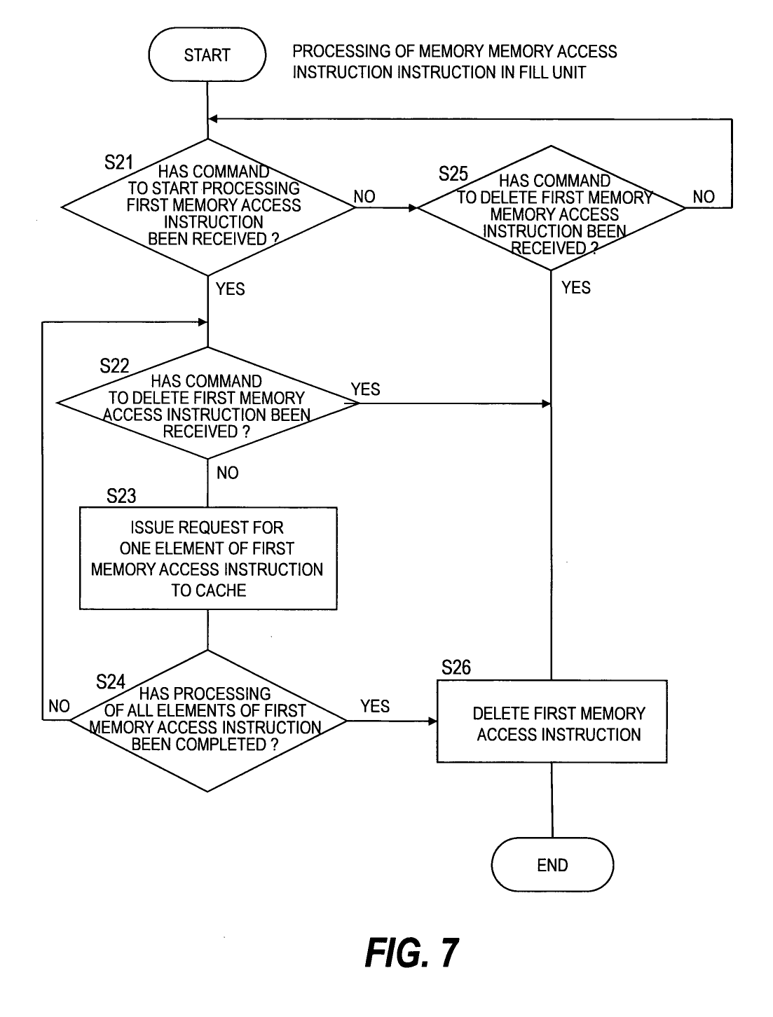

Next, FIG. 7 is a flowchart illustrating an example of memory processing executed in the fill unit 130. The memory processing is issue processing by the fill unit 130 to the cache 200 or the like. In this embodiment, the memory processing corresponds to prefetch processing in response to the memory access instruction with prefetch.

First, in Step S21 in FIG. 7, it is determined whether or not the fill unit 130 has received a command to start processing the memory access instruction read from the fill command queue 131 from the issue control unit 140. If the fill unit 130 has received the processing start command from the issue control unit 140, the processing proceeds to Step S22. If not, the processing proceeds to Step S25.

In Step S22, it is determined whether or not the fill unit 130 has received a command to delete the read memory access instruction from the issue control unit 140. If the fill unit 130 has received the command to delete the read memory access instruction, the processing proceeds to Step S26. If not, the processing proceeds to Step S23.

In Step S23, the fill unit 130 executes the prefetch processing in response to the read memory access instruction. Specifically, the fill unit 130 issues to the cache control unit 210 the fill request for registering data at the address contained in the memory access instruction from the main memory 30 into the cache 200. The memory access instruction may contain a plurality of access elements. The prefetch processing is executed for each of the access elements.

In next Step S24, it is determined whether or not the processing of the memory access instruction has been completed for all the access elements. If not, the processing returns to Step S22 to repeat the above-described processing. If the processing of the memory access instruction has been completed, the processing proceeds to Step S26 where the memory access instruction read into the fill unit 130 is deleted because the memory access instruction has already been executed.

In Step S25 to which the processing proceeds if the fill unit 130 has not received the command to start processing the memory access instruction in Step S21 above, it is determined whether or not the fill unit 130 has received a command to delete the memory access instruction read into the fill unit 130 from the issue control unit 140. If the fill unit 130 has not received the delete command, the processing returns to Step S21 to repeat the above processing. If the fill unit 130 has received the delete command, the processing proceeds to Step S26 where the memory access instruction before being processed is deleted from the fill unit 130 to prevent a needless prefetch.

By the above processing, in response to the command from the issue control unit 140 illustrated in FIG. 6, the fill unit 130 performs the processing on the memory access instruction read from the fill command queue 131 and issues the prefetch command to the cache control unit 210. When the command to delete the memory access instruction is issued from the issue control unit 140, the fill unit 130 discards the memory access instruction read from the fill command queue 131 to prevent a needless prefetch.

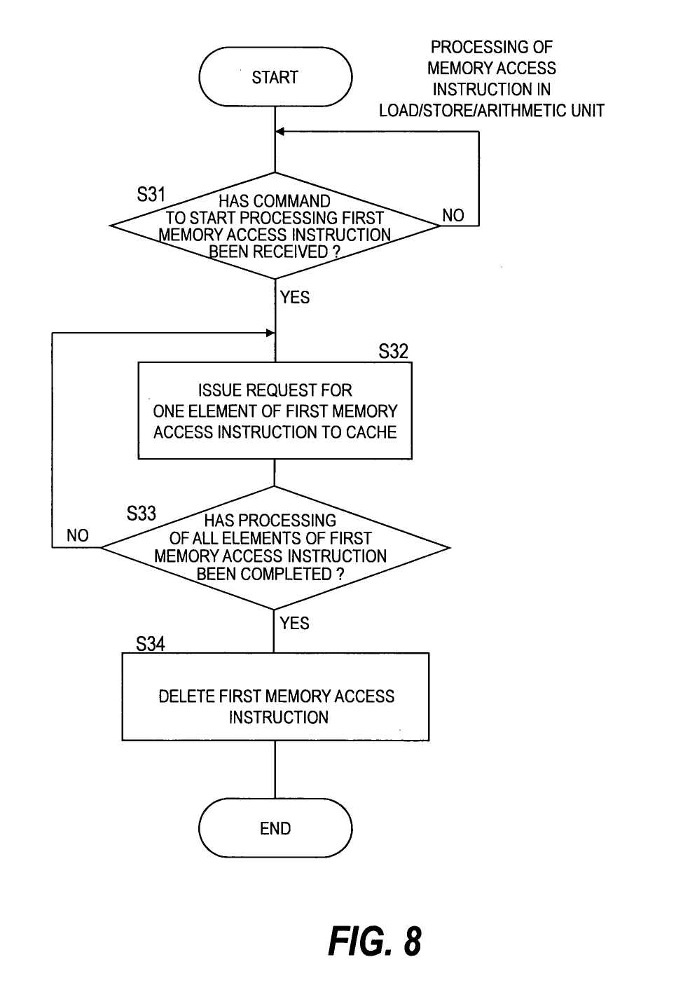

Next, FIG. 8 is a flowchart illustrating an example of memory processing executed in the load/store/arithmetic unit 120. The processing is executed in the load/store/arithmetic unit 120 in a predetermined cycle.

First, in Step S31 in FIG. 8, it is determined whether or not the load/store/arithmetic unit 120 has received a command to start processing the memory access instruction read from the vector command queue 121 from the issue control unit 140. If the load/store/arithmetic unit 120 has received the processing start command from the issue control unit 140, the processing proceeds to Step S32. If not, the processing returns to Step S31 to wait for the processing start command.

Next, in Step S32, the load/store/arithmetic unit 120, which has received the processing start command from the issue control unit 140, executes the memory access instruction read from the vector command queue 121 to access the cache 200 or the main memory 30. As described above, the memory access instruction can contain a plurality of access elements. Access processing is executed for each of the access elements.

In next Step S33, it is determined whether the processing of the memory access instruction has been completed for all the access elements. If not, the processing returns to Step S32 to repeat the above-described processing. If the processing has been completed, the processing proceeds to Step S34 where the memory access instruction read into the load/store/arithmetic unit 120 is deleted because the memory access instruction has already been executed. Then, the processing is terminated.

By the above processing, the load/store/arithmetic unit 120 executes the memory access instruction read from the vector command queue 121 in response to the command from the issue control unit 140 illustrated in FIG. 6. Upon completion of the execution of the memory access instruction, the load/store/arithmetic unit 120 deletes the read memory access instruction to prepare for a next instruction.

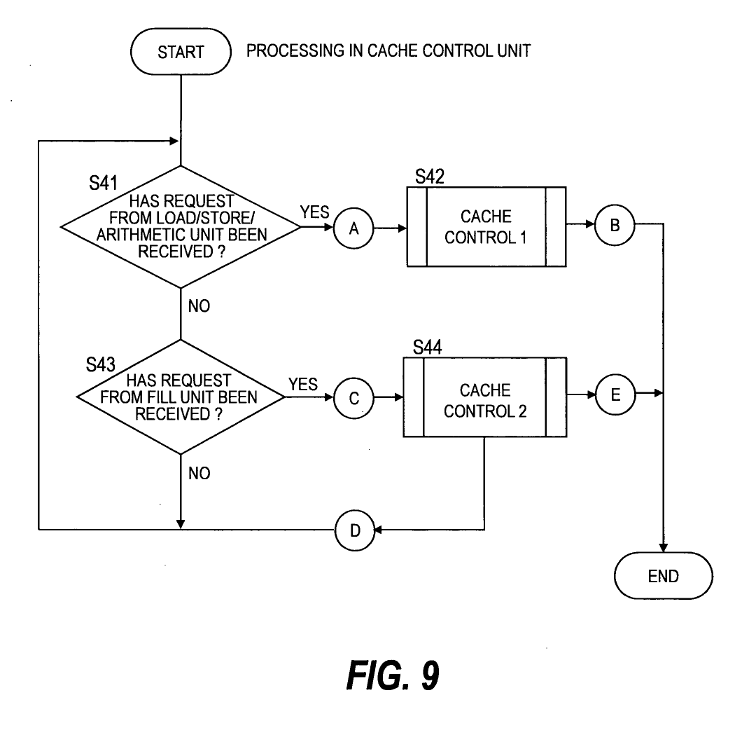

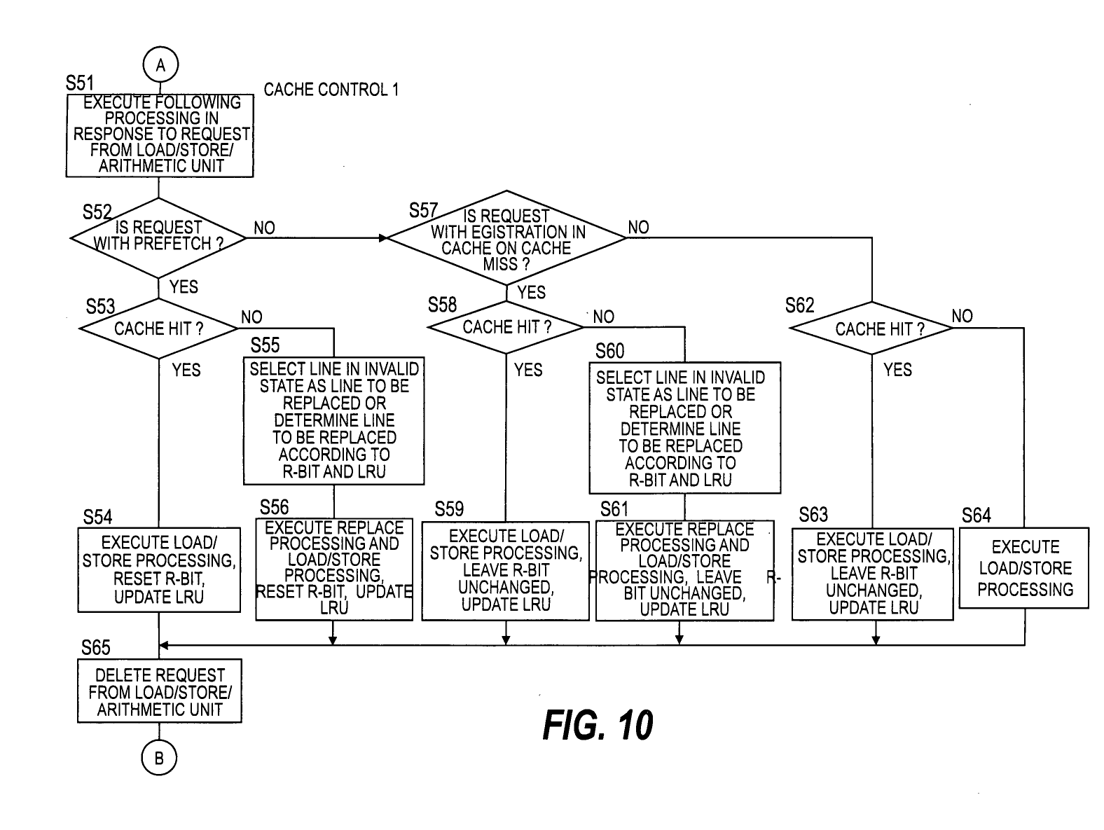

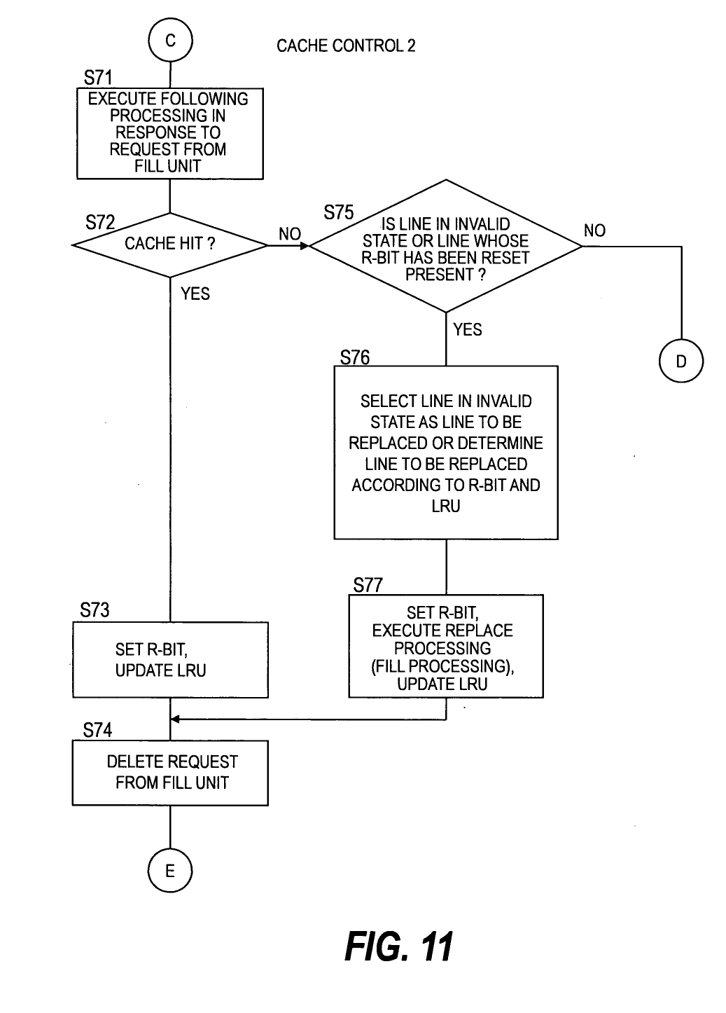

FIGS. 9 to 11 are flowcharts illustrating an example of processing executed in the cache control unit 210. FIG. 9 illustrates a main routine, FIG. 10 is a flowchart illustrating an example of a cache control performed in response to a request from the load/store/arithmetic unit 120, and FIG. 11 is a flowchart illustrating an example of another cache control performed in response to a request from the fill unit 130.

In FIG. 9, it is determined in Step S41 whether or not the cache control unit 210 has received the request (the load instruction or the store instruction) from the load/store/arithmetic unit 120. If the cache control unit 210 has received the request, the processing proceeds to Step S42 where the cache control unit 210 executes a cache control 1 based on the request from the load/store/arithmetic unit 120. If not, the processing proceeds to Step S43 where it is determined whether or not the cache control unit 210 has received the fill request (prefetch command) from the fill unit 130. If the cache control unit 210 has received the fill request, the processing proceeds to Step S44 where a cache control 2 is executed based on the fill request. When the cache control is completed in Step S42 or S44, the processing returns to Step S41 to repeat the above-described processing.

FIG. 10 is a flowchart illustrating the detailed contents of the cache control 1 executed in Step S42 in FIG. 9 described above.

Upon reception of the request (memory access instruction issued) from the load/store/arithmetic unit 120 (S51), the cache control unit 210 first determines in Step S52 whether or not the memory access instruction issued from the load/store/arithmetic unit 120 is the memory access instruction with prefetch (cache load instruction or store instruction with prefetch). If the memory access instruction is the memory access instruction with prefetch, the processing proceeds to Step S53. If the memory access instruction is without prefetch, the processing proceeds to Step S57.

In Step S53, the cache control unit 210 searches for the tag 221 of the cache line 220 corresponding to the address on the main memory 30, which is designated by the memory access instruction with prefetch. If the corresponding cache line 220 is found, it is determined that a cache hit occurs and the processing proceeds to Step S54. On the other hand, if the tag 221 corresponding to the address on the main memory 30 is not found, it is determined that a cache miss occurs and the processing proceeds to Step S55.

In Step S54 to which the processing proceeds when the cache hit has occurred, load or store processing corresponding to the memory access instruction is performed for the cache line 220 for which the cache hit has occurred. Then, since the memory access instruction is with prefetch in this case, the registration state (R-bit in FIG. 10) 222 of the cache line 220 is reset to “0” to indicate that the non-speculatively prefetched data has been used for the memory access instruction with prefetch. In addition, the LRU 223 of the cache line 220, for which the cache hit has occurred, is updated.

Then, the processing proceeds to Step S65. In this step, after the deletion of the memory access instruction received by the cache control unit 210, the processing is terminated.

On the other hand, in Step S55 to which the processing proceeds when the occurrence of the cache miss for the memory access instruction with prefetch is determined in Step S53, the cache line 220 to be replaced is searched for in the following procedures in order to read data of the memory access instruction with prefetch into the cache 200.

1. The cache line 220 in an invalid state is searched for as a target to be replaced.

2. If the cache line 220 in the invalid state is not found, the cache line 220 having the oldest LRU 223 is selected as a target to be replaced from the cache lines 220 whose registration state 222 is reset to “0”.

3. If there is no cache line 220 having the registration state 222 of “0”, the cache line 220 having the oldest LRU 223 is selected as a target to be replaced.

By the procedures 1 to 3 described above, the cache line 220 to be replaced is determined.

For storing new data in the cache 200, the cache control unit 210 determines the cache line 220 in the invalid state by priority as a target to which the data is to be written (target to be replaced). If there is no cache line 220 in the invalid state, however, the cache line 220 whose registration state 222 has been reset to 0 is determined as a target to be replaced among the cache lines 220 for storing the data read by the non-speculative prefetch because the cache line 220 whose registration state 222 has been reset to 0 has a low possibility of being accessed in response to a subsequent memory access instruction. In this case, the selection of the cache line 220 having the oldest LRU 223 can further lower the possibility of access by the subsequent memory access instruction.

The cache control unit 210 manages the cache line 220 by the above-described procedures 1 and 2. As a result, the cache control unit 210 can effectively use the cache 200 while performing the non-speculative prefetch. For some pieces of data, however, when all the cache lines 220 have the registration state 222 of “1” to wait for an access in response to the subsequent memory access instruction, no more data can be cached into the cache 200 if the memory access instruction is issued from the load/store/arithmetic unit 120. Therefore, there is a possibility that the performance of the load/store/arithmetic unit 120 is lowered. In order to avoid such a state, the cache line 220 having the oldest LRU 223 may be released by simply referring to the LRU 223 as in the procedure 3 above.

Next, in Step S56, replace processing for reading the data at the address, for which the cache miss has occurred, to write the read data into the cache line 220 determined in Step S55 above is executed. Thereafter, the load or store processing is executed according to the memory access instruction with prefetch. Upon completion of the load or store processing, the registration state 222 is reset to “0” to indicate that the data has been used for the cache memory access instruction with prefetch corresponding to the fill request. Furthermore, after the update of the LRU 223, the processing proceeds to Step S65 where the memory access instruction received by the cache control unit 210 is deleted. Thereafter, the processing is terminated.

On the other hand, in Step S57 to which the processing proceeds if it is determined in Step S52 that the request from the load/store/arithmetic unit 120 is without prefetch, if the memory access instruction corresponding to the request is for registering the data in the cache 200 on a cache miss illustrated in FIG. 4 (cache load instruction or store instruction without prefetch), the processing proceeds to S58. If not (if the memory access instruction is the cache invalidation load instruction or store instruction), the processing proceeds to Step S62.

In Step S58, the tag 221 of the cache line 220 corresponding to the address on the main memory 30, which is designated by the cache load instruction or store instruction without prefetch, is searched for. If the corresponding cache line 220 is found, it is determined that a cache hit has occurred and the processing proceeds to Step S59. On the other hand, if the tag 221 corresponding to the address on the main memory 30 is not found, it is determined that a cache miss has occurred and the processing proceeds to Step S60.

In Step S59 to which the processing proceeds when the cache hit has occurred, the load or store processing corresponding to the memory access instruction is performed for the cache line 220, for which the cache hit has occurred. Then, the LRU 223 of the cache line 220, for which the cache hit has occurred, is updated. In the case of the cache load instruction or store instruction without prefetch, the prefetched data is not used. Therefore, the registration state 222, which is set when the fill unit 130 caches the data, remains unchanged. Then, the processing proceeds to Step S65 where the memory access instruction received by the cache control unit 210 is deleted. Then, the processing is terminated.

On the other hand, in Step S60 to which the processing proceeds when it is determined in Step S58 that the cache miss has occurred as a result of the memory access instruction without prefetch, the cache line 220 to be replaced is searched for in the procedures 1 to 3 above as in Step S55 to determine the cache line 220 to be replaced in order to read the data corresponding to the memory access instruction without prefetch into the cache 200.

Next, in Step S61, the replace processing for reading data at the address, for which the cache miss has occurred, to write the read data to the cache line 220 determined in Step S60 above is executed. Thereafter, the load or store processing is executed according to the memory access instruction without prefetch. Upon completion of the load or store processing, the processing proceeds to Step S65 where the memory access instruction received by the cache control unit 210 is deleted. Thereafter, the processing is terminated.

On the other hand, in Step S62 to which the processing proceeds when it is determined in Step S57 above that the request from the load/store/arithmetic unit 120 is the cache invalidation load instruction or store instruction, the tag 221 of the cache line 220 corresponding to the address on the main memory 30, which is designated by the cache invalidation load instruction or store instruction, is searched for. If the corresponding cache line 220 is found, it is determined that a cache hit has occurred and the processing proceeds to Step S63. On the other hand, if the tag 221 corresponding to the address on the main memory 30 is not found, it is determined that a cache miss has occurred and the processing proceeds to Step S64.

In Step S63 to which the processing proceeds when the cache hit has occurred, the load or store processing corresponding to the memory access instruction is performed for the cache line 220, for which the cache hit has occurred. Then, the LRU 223 of the cache line 220, for which the cache hit has occurred, is updated. In the case of the cache invalidation load instruction or store instruction, the non-speculatively prefetched data by the fill unit 130 is not used. Therefore, the registration state 222, which is set when the fill unit 130 caches the data, remains unchanged. Then, the processing proceeds to Step S65 where the memory access instruction received by the cache control unit 210 is deleted. Then, the processing is terminated.

On the other hand, in Step S64 to which the processing proceeds when it is determined in Step S62 that the cache miss has occurred as a result of the cache invalidation memory access instruction, the load or store processing is executed not by reading the data into the cache 200 but by directly reading the data from the main memory 30 into the load/store/arithmetic unit 120. Then, upon completion of the load or store processing, the processing proceeds to Step S65 where the memory access instruction received by the cache control unit 210 is deleted. Then, the processing is terminated.

By the above processing, only for the memory access instruction with prefetch, the registration state 222 of the used cache line 220 is reset to “0” to indicate that the non-speculatively prefetched data has been used for the memory access instruction with prefetch. As a result, the cache line 220 can be released. Since the data to be cached on the cache miss is stored in the cache line determined by checking the invalid state of the cache line, whether or not the registration state 222 has been reset, and the LRU 223 in this order, the data non-speculatively prefetched by the fill unit 130 can be prevented from being discarded from the cache 200 before being used.

FIG. 11 is a flowchart illustrating the detailed contents of the cache control 2 executed in Step S44 in FIG. 9 above.

Upon reception of the fill request (prefetch instruction) from the fill unit 130 (S71), the cache control unit 210 first searches for the tag 221 of the cache line 220 corresponding to the address on the main memory 30, which is designated by the prefetch instruction issued by the fill unit 130, in Step S72. If the corresponding cache line 220 is found, it is determined that a cache hit has occurred and the processing proceeds to Step S73. On the other hand, if the tag 221 corresponding to the address on the main memory 30 is not found, it is determined that a cache miss has occurred and the processing proceeds to Step S75.

In Step S73, since the cache line 220, for which the cache hit has occurred, is non-speculatively prefetched data used for a subsequent cache memory access instruction with prefetch, the cache control unit 210 sets “1” for the registration state 222 of the corresponding cache line 220 to prevent the data from being discarded by the replace processing. Moreover, the cache control unit 210 updates the LRU 223 to complete the non-speculative prefetch. Thereafter, in Step S74, the fill request from the fill unit 130, which is read by the cache control unit 210, is deleted. Then, the processing is terminated.

On the other hand, in Step S75 to which the processing proceeds when the cache miss is determined in Step S72 above, the cache line 220 to be replaced is searched for to read the data at the address designated by the prefetch instruction from the main memory 30 to register the read data in the cache 200. By this search, the cache line 220 in the invalid state and the cache line 220 whose registration state 222 has been reset to “0” are searched for to determine whether or not at least one of the cache lines 220 is present.

If the cache line 220 in the invalid state or the cache line 220 whose registration state 222 has been reset is found, the processing proceeds to Step S76. On the other hand, if the cache line 220 to be replaced is not found, the processing returns to Step S41 in FIG. 9 where the cache control unit 210 waits until the replaceable cache line 220 is found.

In Step S76 to which the processing proceeds when the cache line 220 to be replaced is present, the cache line 220 in the invalid state is selected as the cache line 220 to be replaced. If the cache line 220 in the invalid state is not found, the cache line 220 having the oldest LRU 223 is selected as a target to be replaced from the cache lines 220 whose registration state 222 has been reset to “0”.

Next, in Step S77, the replace processing for reading the data at the address, for which the cache miss has occurred, from the main memory 30 to write the read data to the cache line 220 determined in Step S76 above is executed. Since the prefetch is based on the fill request in this case, “1” is set for the registration state 222 of the replaced cache line 220. Then, the data in the cache line 220 is held on the cache 200 until a subsequent memory access instruction with prefetch is issued. Then, the processing proceeds to Step S74 where the fill request received by the cache control unit 210 is deleted. Thereafter, the processing is terminated.

By the above processing, upon reception of the fill request (non-speculative prefetch instruction) from the fill unit 130, the cache control unit 210 sets “1” for the registration state 222 if the data at the designated address is present in the cache 200, thereby explicitly indicating that the data is used for a subsequently executed cache memory access instruction with prefetch to prevent the cache line 220 from being replaced. Then, if the data at the designated address is not present in the cache 200, the cache line 220 in the invalid state or the cache line 220 whose registration state 222 has been reset is selected as a target to be replaced. The data read from the main memory 30 is stored in the selected cache line 220. Furthermore, the registration state 222 is set to “1” to explicitly indicate that the data is used for a subsequent cache memory access instruction with prefetch.

As described above, according to the first embodiment of this invention, the vector processor includes the fill unit 130 for executing the non-speculative prefetch and the load/store/arithmetic unit 120 for executing the memory access instruction to access the cache 200 or the main memory 30 in a separated manner. The issue control unit 140 including the counter 141 controls the prefetch by the fill unit 130 and the memory access by the load/store/arithmetic unit 120. As a result, the non-speculatively prefetched data can be prevented from being discarded from the cache 200 before being accessed, whereas the amount of hardware can be restrained from being increased as in the case of the related art. Furthermore, the issue control unit 140 monitors the number of memory accesses issued by the load/store/arithmetic unit 120 and the number of fill requests issued by the fill unit 130. In this manner, when the number of memory accesses becomes equal to or exceeds the number of fill requests, the fill request is discarded or the fill request is issued in priority to the memory access. As a result, a needless cache access can be prevented to ensure the performance of the vector processor 10.

### Second Embodiment

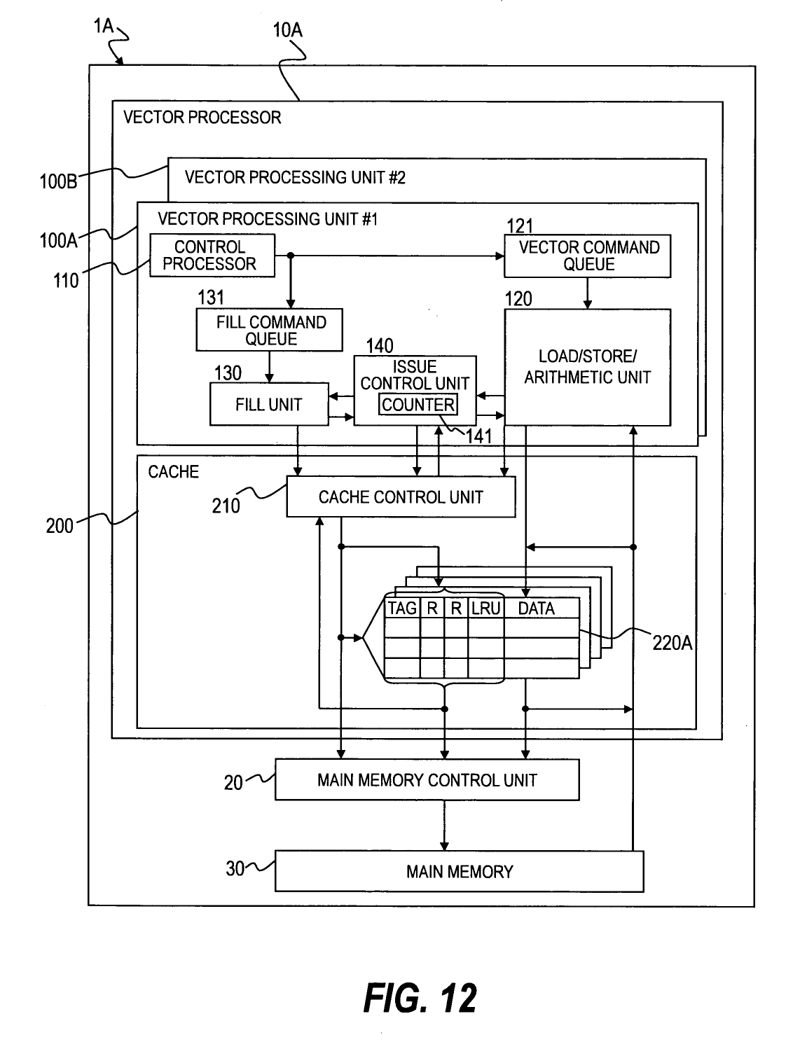

FIG. 12 is a block diagram illustrating a computer according to a second embodiment of this invention. The second embodiment differs from the first embodiment in that the single-core vector processor in the first embodiment is replaced by a multi-core (dual-core) vector processor 10A in the second embodiment.

A computer 1A includes the multi-core vector processor 10A including a plurality of vector processing units 100A and 100B, the main memory 30 for storing data and programs, the main memory control unit 20 for accessing the main memory 30 based on an access request (read or write request) from the vector processor 10A.

The vector processor 10A includes the cache 200 for temporarily storing the data or the instruction read from the main memory 30 and the vector processing units 100A and 100B for reading the data stored in the cache 200 to perform the vector operation. The cache 200 is shared by the plurality of vector processing units 100A and 100B.

The configuration of each of the vector processing units 100A and 100B is the same as that of the vector processing unit 100 in the first embodiment. Specifically, each of the vector processing units 100A and 100B includes the control processor 110 for controlling the entire vector processing unit, the fill unit 130 for executing the non-speculative prefetch and the load/store/arithmetic unit 120 for making the memory access, and the issue control unit 140 including the counter 141. The fill unit 130 and the load/store/arithmetic unit 120 are provided in a separated manner, and the issue control unit 140 controls the non-speculative prefetch and the memory access.

The configuration of the cache 200 is the same as that of the first embodiment except for a cache line 220A. The same components as those in the first embodiment are denoted by the same reference numerals.

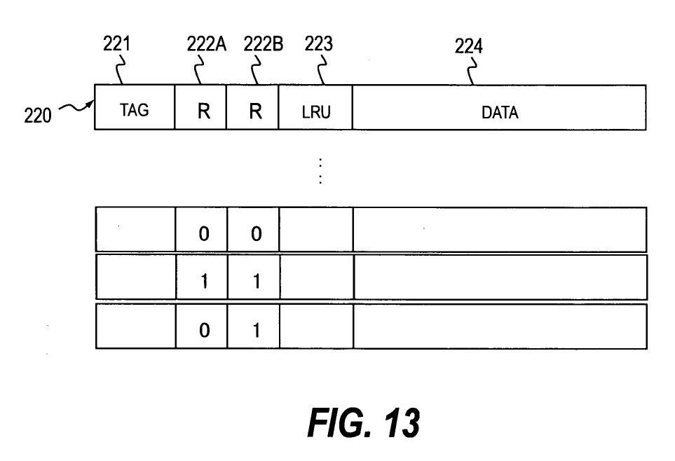

The cache line 220A is the same as the cache line 200 in the first embodiment except for the following points. As illustrated in FIG. 13, the cache line 220A contains a registration state 222A for storing a state of use for the cache memory access instruction with prefetch based on the request from the fill unit 130 and the load/store/arithmetic unit 120 of the vector processing unit 100A and a registration state 222B for storing a state of use for the cache memory access instruction with prefetch based on the request from the fill unit 130 and the load/store/arithmetic unit 120 of the vector processing unit 100B.

After storing data, which is read from the main memory 30 into the cache 200, in the cache line 220A in response to the fill request from the fill unit 130, the cache control unit 210 sets “1” for one of the registration states 222A and 222B of the cache line 220A corresponding to the vector processing unit which has issued the fill request, thereby explicitly indicating that the cache line 220A is used for a subsequent memory access instruction.

When the load/store/arithmetic unit 120 of the vector processing unit 100A issues the cache memory access instruction with prefetch, the cache control unit 210 executes the load or store processing according to the memory access instruction for the corresponding cache line 220A to reset the registration state 222A to “0”.

When the load/store/arithmetic unit 120 of the vector processing unit 100B issues the cache memory access instruction with prefetch, the cache control unit 210 executes the load or store processing according to the memory access instruction for the corresponding cache line 220B to reset the registration state 222B to “0”.

For replacing the cache line as a result of occurrence of a cache miss, the cache control unit 210 selects the cache line 220A in the invalid state and the cache line 220A whose registration states 222A and 222B have both been reset as cache lines to be replaced.

Therefore, the cache line 220A with at least one of the registration states 222A and 222B being set to “1” is held in the cache 200 until the plurality of vector processing units 100A and 100B make an access in response to the cache memory access instruction with prefetch. As a result, even when the multi-core vector processor 10A is used, the non-speculatively prefetched data can be prevented from being discarded from the cache 200 before being accessed, whereas the amount of hardware can be restrained from being increased as in the case of the related art.

Next, a control performed in the vector processor 10A differs from that in the first embodiment only in a part of the control performed by the cache control unit 210 of the first embodiment illustrated in FIGS. 9 to 11. The other control performed by the issue control unit 140, the fill unit 130 and the load/store/arithmetic unit 120 is the same as that in the first embodiment.

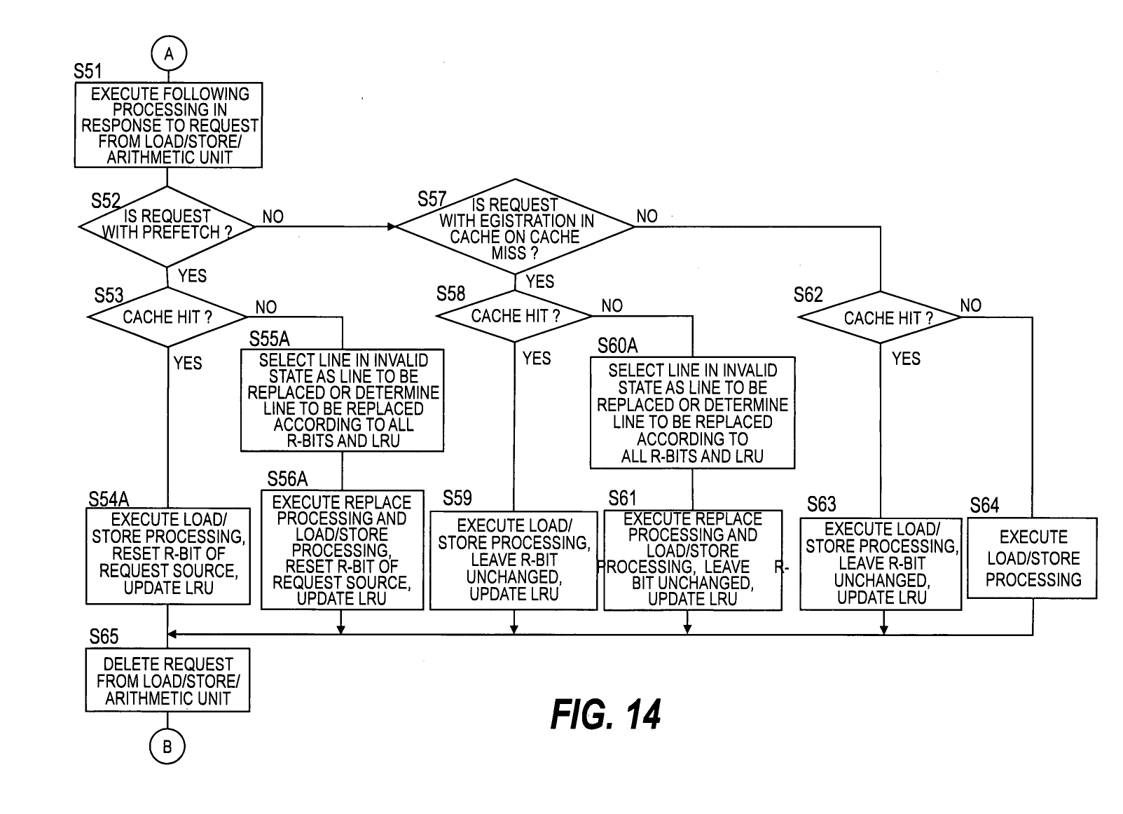

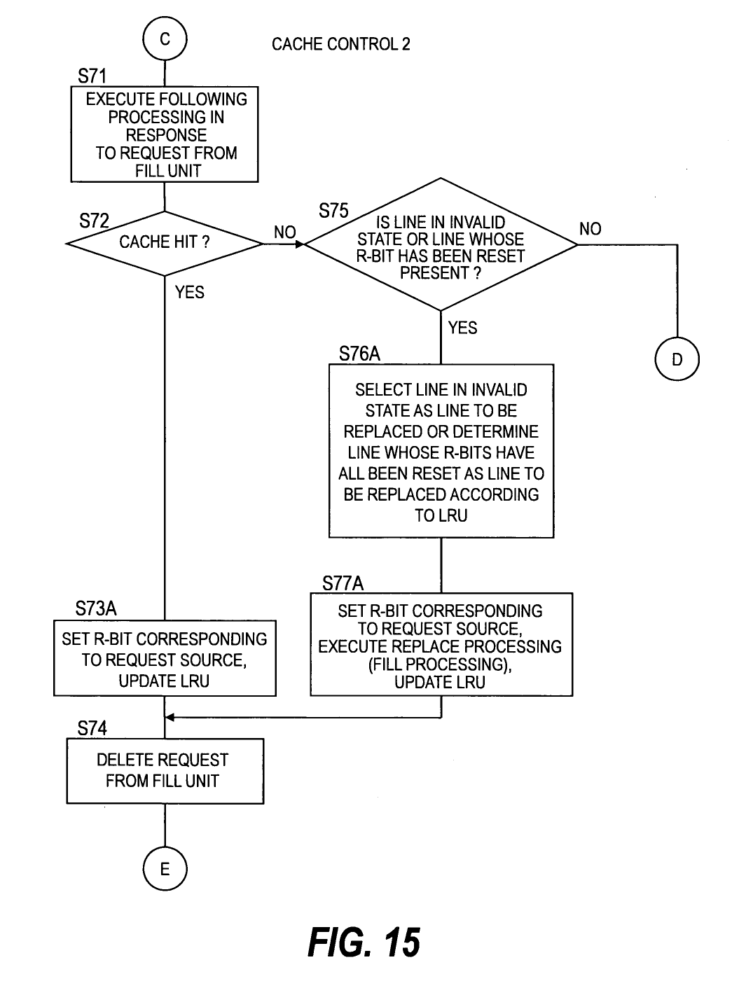

The control performed in the cache control unit 210 in the second embodiment differs from that in the first embodiment in that the registration states (R-bits) 222A and 222B at the execution of the memory access instruction are operated for each of the vector processing units 100A and 100B, as illustrated in FIGS. 14 and 15. The other part of the control is the same as that of the first embodiment. FIG. 14 is a modification of a part of the processing performed in the cache control unit 210 in response to the request from the load/store/arithmetic unit 120 in the first embodiment, illustrated in FIG. 10, whereas FIG. 15 is a modification of a part of the processing performed in the cache control unit 210 in response to the fill request from the fill unit 130 in the first embodiment, illustrated in FIG. 11.

In FIG. 14, processing different from that illustrated in FIG. 10 in the first embodiment is as follows.

In Step S54A to which the processing proceeds when the cache hit occurs as a result of the cache memory access instruction with prefetch, the load or store processing corresponding to the memory access instruction from the load/store/arithmetic unit 120 is executed for the cache line 220A for which the cache hit has occurred. Then, the registration state (R-bit in FIG. 14) 222A or 222B of the cache line 220A, which corresponds to the vector processing unit 100A or 100B having issued the memory access instruction, is reset to “0”. As a result, the vector processing unit 100A or 100B which has issued the memory access instruction, for which the non-speculatively prefetched data is used, is indicated. The update of the LRU 223 of the cache line 220A, for which the cache hit has occurred, is the same as in the first embodiment.

Next, in Step S55A to which the processing proceeds when the cache miss has occurred as the result of the cache memory access instruction with prefetch, the cache line 220A to be replaced is searched for in the following procedures.

1. The cache line 220A in the invalid state is searched for as a target to be replaced.

2′. If the cache line 220A in the invalid state is not found, the cache line 220A having the oldest LRU 223 is selected as a target to be replaced from the cache lines 220A whose registration states 222A and 222B have both been reset to “0”.

3. If there is no cache line 220A whose registration states 222A and 222B are both “0”, the cache line 220A having the oldest LRU 223 is selected as a target to be replaced.

By the procedures 1 to 3 described above, the cache line 220A to be replaced is determined.

Next, in Step S56A, the replace processing for reading the data at the address, for which the cache miss has occurred, to write the read data in the cache line 220A determined in Step S55A above is executed. Thereafter, the load or store processing is executed according to the memory access instruction with prefetch. Upon completion of the load or store processing, the registration state 222A or 222B, which corresponds to the vector processing unit 100A or 100B having issued the memory access instruction, is reset to “0”, thereby explicitly indicating the vector processing unit which has issued the cache memory access instruction with prefetch corresponding to the fill request, for which the data is used. For example, when the vector processing unit 100A issues the cache memory access instruction with prefetch, the cache control unit 210 resets the registration state 222A to “0” without changing the other registration state 222B. Therefore, until all the vector processing units issue the cache memory access instructions to the cache line 220A, the cache line 220A is held on the cache 200.

In the Step S60A to which the processing proceeds if the cache miss has occurred as a result of the cache memory access instruction without prefetch, the cache line 220A to be replaced is selected from the cache lines 220A in the invalid state or the cache lines 220A whose registration states 222A and 222B have both been reset as in the case of Step S55A in order to read the data for the cache memory access instruction without prefetch into the cache 200. The remaining processing in FIG. 14 is the same as that illustrated in FIG. 10 in the first embodiment.

Next, in FIG. 15, processing different from that in FIG. 11 in the first embodiment is as follows.

In Step S73A to which the processing proceeds if the cache hit has occurred as a result of the fill request from the fill unit 130, “1” is set for the registration state 222A or 222B corresponding to the vector processing unit 100A or 100B which has issued the fill request to the cache control unit 210 to prevent the cache line 220A from being discarded by the replace processing. Specifically, “1” is set only for the registration state 222A or 222B corresponding to the vector processing unit which has issued the fill request.

Next, in Step S76A to which the processing proceeds if the cache miss has occurred as a result of the fill request from the fill unit 130 and the cache line 220A in the invalid state or whose registration states 222A and 222B have both been reset is found, the cache line 220A in the invalid state is selected as a target to be replaced. If the cache line 220A in the invalid state is not present, the cache line 220A whose registration states 222A and 222B have both been reset to “0” with the oldest LRU 223 is selected. If the cache line 220A whose registration states 222A and 222B have both been reset to “0” is not present, the cache line 220A having the oldest LRU 223 is selected as a target to be replaced.

Next, in Step S77A, the replace processing is executed to read the data at the address, for which the cache miss has occurred, to write the read data to the cache line 220A determined in Step S76 above. At this time, “1” is set for one of the registration states 222A and 222B, which corresponds to the vector processing unit 100A or 100B having issued the fill request.

As described above, even in the vector processor 10A including the plurality of vector processing units as in the second embodiment of this invention, the cache line 220A with at least one of the registration states 222A and 222B being set to “1” is held on the cache 200 until the vector processing unit 100A or 100B which has issued the fill request makes an access in response to the cache memory access instruction with prefetch. As a result, even when the multi-core vector processor 10A is used, the non-speculatively prefetched data can be prevented from being discarded from the cache 200 before being accessed, whereas the amount of hardware can be restrained from being increased as in the related art.

Furthermore, if the number of memory accesses becomes equal to or exceeds the number of fill requests, the issue control unit 140 discards the fill request or issues the fill request in priority to the memory access. As a result, a needless cache access can be prevented to ensure the performance of the multi-core vector processor 100A.

<Supplementary Description>

Although 0 or 1 is set for the registration state 222 (or the registration states 222A and 222B) in the above-described embodiments, a counter may be used instead. When a plurality of vector processors access the same cache line 220, the cache line 220 can be held on the cache 200 until the accesses by all the vector processors are completed by setting the number of accesses to the counter.

Although the vector processor 10 and the main memory control unit 20 are coupled to each other through the front side bus in the above-described embodiments, the main memory control unit may be provided in the vector processor 10 to couple the main memory control unit in the vector processor 10 and the main memory 30 through a memory bus.

Moreover, although this invention is applied to the vector processor in each of the above-described embodiments, this invention may be applied to a scalar processor.

Furthermore, although this invention is applied to the single cache 200 in each of the above-described embodiments, this invention can be applied to a cache having a multi-level structure.

As has been described above, this invention can be applied to a processor provided with a cache memory and a computer including a processor provided with a cache memory.

While the present invention has been described in detail and pictorially in the accompanying drawings, the present invention is not limited to such detail but covers various obvious modifications and equivalent arrangements, which fall within the purview of the appended claims.

What is claimed is:

1. A cache memory comprising:
a cache control unit for reading data from a main memory to the cache memory to register the data in the cache memory upon reception of a fill request from a processor and for accessing the data in the cache memory upon reception of a memory access instruction from the processor, the processor including: a control unit for issuing the memory access instruction including a load instruction for reading the data from the cache memory and a store instruction for writing the data to the cache memory, and an arithmetic instruction for the data; an instruction executing unit for executing the instruction issued by the control unit; and a fill unit for receiving the memory access instruction issued by the control unit to issue the fill request for reading the data into the cache memory to the cache memory; and
a plurality of cache lines, each being for storing the data in association with an address on the main memory,
wherein each of the plurality of cache lines includes a registration information storage unit for storing information indicating whether the data registered in the each of the plurality of cache lines is written to the each of the plurality of cache lines in response to the fill request and whether the data registered in the each of the plurality of cache lines is accessed by the memory access instruction, and
wherein the cache control unit sets predetermined information to the registration information storage unit when the data read from the main memory is registered in one of the plurality of cache lines based on the fill request and resets the predetermined information in the registration information storage unit when the data in the one of the plurality of cache lines is accessed based on the memory access instruction.

2. The cache memory according to claim 1, wherein the cache control unit selects one of the plurality of cache lines, in which the predetermined information in the registration information storage unit has been reset, when new data is read from the main memory to be registered in the cache memory.

3. The cache memory according to claim 2, wherein the cache control unit determines that a cache miss has occurred when data requested by one of the fill request and the memory access instruction from the processor is absent in the cache memory and then reads the data requested by the one of the fill request and the memory access instruction from the main memory to register the data in the cache memory.

4. The cache memory according to claim 1,
wherein the processor comprises:
a first processing unit including the control unit, the instruction executing unit, and the fill unit; and
a second processing unit including: a second control unit for issuing the memory access instruction including the load instruction for reading the data from the cache memory and the store instruction for writing the data to the cache memory, and the arithmetic instruction for the data; a second instruction executing unit for executing the instruction issued by the second control unit; and a second fill unit for receiving the memory access instruction issued by the second control unit to issue the fill request for reading the data into the cache memory to the cache memory,
wherein the registration information storage unit of each of the plurality of cache lines includes: a first storage unit for storing the information in response to one of the fill request and the memory access instruction from the first processing unit; and a second storage unit for storing the information in response to one of the fill request and the memory access instruction from the second processing unit, and
wherein the cache control unit is configured to:
set predetermined information in the first storage unit of the registration information storage unit when the data read from the main memory based on the fill request from the first processing unit is registered in one of the plurality of cache lines and reset the predetermined information in the first storage unit of the registration information storage unit when the data in the one of the plurality of cache lines is accessed based on the memory access instruction from the first processing unit; and
set predetermined information in the second storage unit of the registration information storage unit when the data read from the main memory based on the fill request from the second processing unit is registered in one of the plurality of cache lines and reset the predetermined information in the second storage unit of the registration information storage unit when the data in the one of the plurality of cache lines is accessed based on the memory access instruction from the second processing unit.

5. The cache memory according to claim 1,
wherein the memory access instruction includes a first memory access instruction with the fill request being issued from the fill unit and a second memory access instruction without issuing the fill request from the fill unit, and
wherein the cache control unit resets the predetermined information in the registration information storage unit upon reception of the first memory access instruction from the processor and forbids an operation for the registration information storage unit upon reception of the second memory access instruction from the processor.

6. A processor comprising:
a cache memory including a plurality of cache lines, each being for storing data in association with an address of a main memory;
a control unit for issuing a memory access instruction including a load instruction for reading data from the cache memory and a store instruction for writing data to the cache memory, and an arithmetic instruction for the data;
an instruction executing unit for executing the instruction issued by the control unit;
a fill unit for receiving the memory access instruction issued by the control unit to issue a fill request for reading the data into the cache memory to the cache memory; and
a cache control unit for reading the data from the main memory into the cache memory to register the data in the cache memory upon reception of the fill request and for accessing the data in the cache memory upon reception of the memory access instruction from the instruction executing unit,
wherein each of the plurality of cache lines includes a registration information storage unit for storing information indicating whether the data registered in the each of the plurality of cache lines is written to the each of the plurality of cache lines in response to the fill request and whether the data registered in the each of the plurality of cache lines is accessed in response to the memory access instruction, and
wherein the cache control unit sets predetermined information to the registration information storage unit for registering the data read from the main memory based on the fill request in one of the plurality of cache lines and resets the predetermined information in the registration information storage unit for accessing the data in the one of the plurality of cache lines based on the memory access instruction.

7. The processor according to claim 6, wherein the cache control unit selects one of the plurality of cache lines, in which the predetermined information in the registration information storage unit has been reset, when new data is read from the main memory to be registered in the cache memory.

8. The processor according to claim 7, wherein the cache control unit determines that a cache miss has occurred when data requested by one of the fill request from the fill unit and the memory access instruction from the instruction executing unit is absent in the cache memory and then reads the data requested by the one of the fill request and the memory access instruction from the main memory to register the data in the cache memory.

9. The processor according to claim 6,
wherein the processor comprises:
a first processing unit including the control unit, the instruction executing unit, and the fill unit; and
a second processing unit including: a second control unit for issuing the memory access instruction including the load instruction for reading the data from the cache memory and the store instruction for writing the data to the cache memory, and the arithmetic instruction for the data; a second instruction executing unit for executing the instruction issued by the second control unit; and a second fill unit for receiving the memory access instruction issued by the second control unit to issue the fill request for reading the data into the cache memory to the cache memory,
wherein the registration information storage unit of each of the plurality of cache lines includes: a first storage unit for storing the information in response to one of the fill request and the memory access instruction from the first processing unit; and a second storage unit for storing the information in response to one of the fill request and the memory access instruction from the second processing unit, and
wherein the cache control unit is configured to:
set predetermined information in the first storage unit of the registration information storage unit when the data read from the main memory based on the fill request from the first processing unit is registered in one of the plurality of cache lines and reset the predetermined information in the first storage unit of the registration information storage unit when the data in the one of the plurality of cache lines is accessed based on the memory access instruction from the first processing unit; and
set predetermined information in the second storage unit of the registration information storage unit when the data read from the main memory based on the fill request from the second processing unit is registered in one of the plurality of cache lines and reset the predetermined information in the second storage unit of the registration information storage unit when the data in the one of the plurality of cache lines is accessed based on the memory access instruction from the second processing unit.

10. The processor according to claim 6,
wherein the memory access instruction includes a first memory access instruction with the fill request being issued from the fill unit and a second memory access instruction without issuing the fill request from the fill unit, and
wherein the cache control unit resets the predetermined information in the registration information storage unit upon reception of the first memory access instruction from the instruction executing unit and forbids an operation for the registration information storage unit upon reception of the second memory access instruction from the instruction executing unit.

11. The processor according to claim 6, further comprising an issue control unit for controlling the fill unit by counting the number of the fill requests issued by the fill unit and the number of the memory access instructions issued by the instruction executing unit to prevent the number of the memory access instructions from being equal to or larger than the number of the fill requests.

12. The processor according to claim 11, wherein the issue control unit commands the fill unit to issue the fill request in priority to the memory access instruction issued by the instruction executing unit when the number of the memory access instructions becomes equal to the number of the fill requests.

13. The processor according to claim 11, wherein the issue control unit commands the fill unit to discard the fill request in the fill unit when a difference between the number of the memory access instructions and the number of the fill requests has a predetermined value.
